(19) United States
(12) Patent Application Publication
(10) Pub. No.: US 2012/0222790 A1
(43) Pub. Date: Sep. 6, 2012

(54) PNEUMATIC TIRE WITH TWO CARCASS PLIES

(75) Inventors: Shawn COPELAND, Wadsworth, OH (US); Michael CRANO, Wadsworth, OH (US)

(73) Assignee: BRIDGESTONE AMERICAS TIRE OPERATIONS, LLC, Nashville, TN (US)

(21) Appl. No.: 13/039,412

(22) Filed: Mar. 3, 2011

(51) Int. Cl. B60C 3/04; B60C 9/02

(52) U.S. Cl. 152/454; 152/548; 152/564

(57) ABSTRACT

Various embodiments of a pneumatic tire include a tread portion, a first bead portion and a second bead portion which are axially spaced, a first sidewall portion and a second sidewall portion and a first and second carcass ply. The first carcass ply includes a main portion which extends circumferentially about the tire from the first bead portion to the second bead portion, a first turned-up portion around the first bead portion and a second turned-up portion around the second bead portion such that the first and second turned-up portions each have an end which terminates along the tread portion. The second carcass ply extends circumferentially about the tire along the first sidewall and along the second sidewall. The second carcass ply has a first end and a second end which terminates in the lower portion of the tire.

### FIELD OF INVENTION

The present disclosure relates to a pneumatic tire. More specifically, the present disclosure relates to a pneumatic tire having an improved carcass structure to improve sidewall performance of the tire.

### BACKGROUND

In an inflated and loaded condition, a radial tire is subject to bending moments at the sidewall areas at the center of the tire footprint. The strains and stresses created by the moments are directly related to the sidewall performance of the tire.

Previous research and studies have demonstrated that the maximum sidewall surface strain occurs in the least stiff area of the sidewall of the tire. The cords embedded within the carcass plies of the sidewalls become compressed during the loading of the tire and the combined cord tension in the upper sidewall area is consequently reduced. Therefore, the maximum sidewall surface strain is typically located in the upper sidewall area which is an area that is most vulnerable to sidewall bending.

Still more recent trends show tires becoming larger but also sidewalls becoming shorter, therefore resulting in even higher stress concentration in the upper portion of the sidewalls. In such tires having relatively lower aspect ratio, for example an aspect ratio of 55 and lower, the “contained energy” is high. Accordingly, there is a need for tire constructions which are capable of achieving higher performance in the sidewalls of the tires.

### SUMMARY

Various embodiments of a pneumatic tire are disclosed, comprising at least two carcass plies. In one embodiment, a pneumatic tire includes a circumferential tread, a pair of sidewalls, and a pair of bead portions, each having a bead core and a bead filler. The tire further includes a first carcass ply extending circumferentially about the tire and having a main portion and two turned-up portions which wrap around the bead portions. The second carcass ply extending circumferentially about the tire and has ends which terminate in the lower portion of the sidewall. In one embodiment the second carcass ply is disposed between the first carcass ply and the sidewall, and in an alternative embodiment the second carcass ply is disposed between the main portion and the turned-up ends of the first carcass ply.

### DESCRIPTION OF THE DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is a cross-sectional view of one embodiment of a pneumatic tire; and

FIG. 2 is cross-sectional view of an alternative embodiment of a pneumatic tire.

### DETAILED DESCRIPTION

The following includes definitions of selected terms employed herein. The definitions include various examples and/or forms of components that fall within the scope of a term and that may be used for implementation. The examples are not intended to be limiting. Both singular and plural forms of terms may be within the definitions.

“Equatorial Plane (EP)” means the plane perpendicular to the tire's axis of rotation and passing through the center of its tread.

“Section Height” means the radial distance from the nominal rim diameter to the outer diameter of the tire at its equatorial plane.

“Section Width” means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Aspect Ratio” means the ratio of a tire's section height to its section width.

“Ply” means a continuous layer of rubber-coated parallel cords.

“Sidewall” means that portion of a tire between the tread and the bead.

“Shoulder” means the upper portion of sidewall just below the tread edge.

“Tread” refers to that portion of the tire that comes into contact with the road under normal load.

“Tread Width” means the arc length of the tread surface in the axial direction, that is, in a plane parallel to the axis of rotation of the tire.

“Axial” and “axially” means the lines or directions that are parallel to the axis of rotation of the tire.

“Circumferential” and “circumferentially” refer to lines or directions extending along the perimeter of the surface of the tread parallel to the equatorial plane perpendicular to the axial direction of the tire.

“Lateral” or “laterally” refer to a direction along the tread of the tire going from one sidewall of the tire to the other sidewall.

“Radial” or “radially” refer to a direction perpendicular to the axis of rotation of the tire.

Directions are also stated in this application with reference to the axis of rotation of the tire. The terms “upward” and “upwardly” refer to a general direction towards the tread of the tire, whereas “downward” and “downwardly” refer to the general direction towards the axis of rotation of the tire. Thus, when relative directional terms such as “upper” and “lower” are used in connection with an element, the “upper” element is spaced closer to the tread than the “lower” element. Additionally, when relative directional terms such as “above” or “below” are used in connection with an element, an element that is “above” another element is closer to the tread than the other element. The terms “inward” and “inwardly” refer to a general direction towards the equatorial plane of the tire, whereas “outward” and “outwardly” refer to a general direction away from the equatorial plane of the tire and towards the sidewall of the tire. Thus, when relative directional terms such as “inner” and “outer” are used in connection with an element, the “inner” element is spaced closer to the equatorial plane of the tire than the “outer” element.

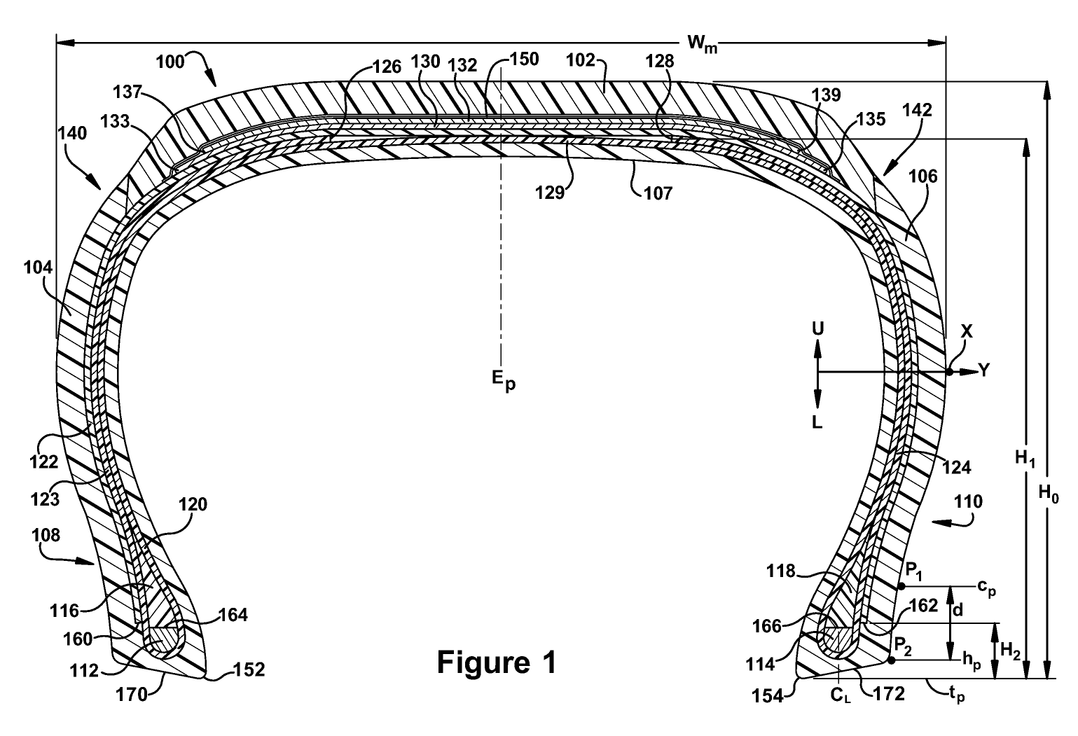

FIG. 1 shows a cross-sectional view of a tire 100. The tire 100 has an equatorial plane Eₚ and a maximum section width Wₘ is equal to twice the distance measured from the equatorial plane Eₚ to the outer most point of the tire 100 (i.e., point X). The tire 100 can be divided into two sections, an upper section U and a lower section L. Separating the upper section U from the lower section L is an imaginary line Y drawn through point X that is substantially parallel to the axis of rotation of the tire 100. The upper section U is the portion of the tire 100 that is disposed above the maximum section width Wₘ of the tire 100 (represented by line Y), while the lower section L is disposed below the maximum section width Wₘ of the tire 100 (represented by line Y).

With continued reference to FIG. 1, the tire 100 includes a tread 102 provided in the upper section U of the tire 100, sidewalls 104, 106 provided in both the upper and lower sections U, L of the tire 100, and a pair of bead portion 108, 110 provided in the lower section L of the tire 100. The bead portions 108, 110 include bead cores 112, 114, respectively, and bead fillers 116, 118, respectively. In alternative embodiments, it is also possible that the bead portions extend into the upper sections U of the tire.

The tire 100 includes first carcass ply 120 extends circumferentially about the tire 100 from one bead portion 108 to the other bead portion 110. A second carcass ply 122 extends circumferentially about the tire from along one sidewall 104 to the other sidewall 106. In one embodiment the first carcass ply 120 is wound outwardly, from the inside out, about the bead cores 108, 110 to form turned-up portions 123, 124, which extend upwardly beyond the shoulders 140, 142 and towards the tread 102. Each turned-up portion 123, 124 of the first carcass ply 120 has an end 126, 128, respectively, and is shown in contact with the main portion 129 of the first carcass ply.

With continued reference to FIG. 1, the tire 100 further includes at least one belt, for example belts 130, 132 that extend circumferentially about the tire 100 beneath the tread 102. Although the tire 100 illustrated in FIG. 1 features two belts, the tire 100 can include a single belt or more than two belts in alternative embodiments (not shown). The belts 130, 132 as shown are disposed between the tread 102 and carcass plies 120, 122 such that the main portion 129 and the ends 126, 128 of the first carcass ply 120 are disposed beneath the belts 130, 132. Belt 130 has edges 133, 135, and belt 132 has edges 137, 139, which terminate inward of shoulder regions 140, 142, respectively of the tire 100. In one embodiment the ends 126, 128 of the first carcass ply 120 terminate beneath the widest belt, for example belt 130 as shown. In an alternative embodiment the ends 126, 128 of the first carcass ply 120 terminate at a distance of 15 to 50 millimeters from the edges 133 and 135 of the widest belt 130. In another alternative embodiment the ends 126, 128 of the first carcass ply 120 terminate at a distance of 15 to 35 millimeters from the edges 133 and 135 of the widest belt 130. In yet another alternative embodiment the ends 126, 128 of the first carcass ply 120 terminate at a distance of 25 to 35 millimeters from the edges 133 and 135 of the widest belt 130.

One or more of the belts, for example belts 130, 132 can include parallel-aligned cords or wires that are radially disposed. In alternative embodiments, one or more of the belts can include parallel-aligned cords or wires that are biased with respect to the equatorial plane Eₚ of the tire 100. In all cases, the cords or wires can be constructed of metal (e.g., steel or other metal alloys) or polymers (e.g., polyimide, polyester, or aramid fibers). The tire 100 can optionally further includes a tread cap 150 provided between the tread 102 and the belts 130, 132. The tread cap 150 can be used to assist in holding the components of the tire together (e.g., the belts, plies, and tread). The tread cap 150 can include, for example, one or more polyester or nylon fabric plies.

As shown in FIG. 1, the section height H₀, of tire 100 is measured from the outer surface of tread 102 at the equatorial plane Eₚ to toes 152, 154 which pass through toe plane tₚ. The height H₁ of the turned-up portions 123, 124 of the first carcass ply 120 is measured radially from the toes 152, 154, to the ends 126, 128 of turned-up portions. Height H₁ of the turned-up portions 123, 124 may ranges from 70% to 99% of the section height H₀.

As mentioned above, the second carcass ply 122 extends circumferentially about the tire 100 along one sidewall 104 to the other sidewall 106. In one embodiment the second carcass ply 122 has ends 160, 162 which terminate in the lower section L of the tire 100. In another embodiment the ends 160, 162 of the second carcass ply extend along bead portions 108, 110, respectively, where the bead portions 108, 110 can extend anywhere along the lower section L of the tire and even slightly above the lower section L and into the upper section U of the tire. The location at which the ends 160, 162 of second carcass ply 120 terminate along the sidewalls can be expressed in terms of the section height H₀ of the tire. For example, the ends 160, 162 of second carcass ply 122 can terminate at a height H₂ measured from the toe plane tₚ which is up to 55% of the section height H₀ of the tire 100. In an alternative embodiment, the height H₂ is 1% to 20% of the section height H₀ of the tire 100. In another alternative embodiment, the height H₂ is 5% to 20% of the section height H₀ of the tire 100.

In another embodiment, the ends 160, 162 extend substantially lower along the sidewalls to a location proximate the bead cores 112, 114, respectively. For example, the ends 160, 162 may extend slightly above top surfaces 164, 166, respectively of the bead cores 112, 114, respectively. In another embodiment, the ends 160, 162 of the second carcass ply can terminate at a minimum and maximum distance d above the heel plane hₚ of the tire 100. For example, end 162 of carcass ply 122 can be located adjacent to point P₁ along carcass plane cₚ which is above heel P₂ which extends along the heel plane, hₚ. In one embodiment the end 162 of second carcass ply 122 terminates at a distance d which is a maximum distance of about 30 millimeters. In an alternative embodiment, the end 162 of second carcass ply 122 terminates at a maximum distance of about 25 millimeters. In another alternative embodiment, the end 162 of second carcass ply 122 terminates at a maximum distance of about 20 millimeters above the heel P₂ of the tire.

In some instances, air migration through flanges 170, 172 of the tire can weaken the strength of the carcass ply. Accordingly, it is also desirable that the ends 160, 162 of second carcass ply terminate at a minimum distance above the heel plane hₚ so that air does not migrate through the carcass ply 122 to cause premature degradation of the second carcass ply. In one embodiment the end 162 of second carcass ply 122 terminates at a distance d which is at least 5 millimeters above the heel P₂ of the tire. In an alternative embodiment, the end 162 of second carcass ply 122 terminates at least 10 millimeters above the heel P₂ of the tire. In another alternative embodiment, the end 162 of second carcass ply 122 terminates at least 13 millimeters above the heel P₂ of the tire. In other alternative embodiments, the ends of the second carcass ply 122 can wrap inwardly, from the outside toward the inside, around the bead cores 112, 114 and it is desirable that the second carcass ply does not extend beyond the centerline, C_{L}, of the bead portions 112 and 114.

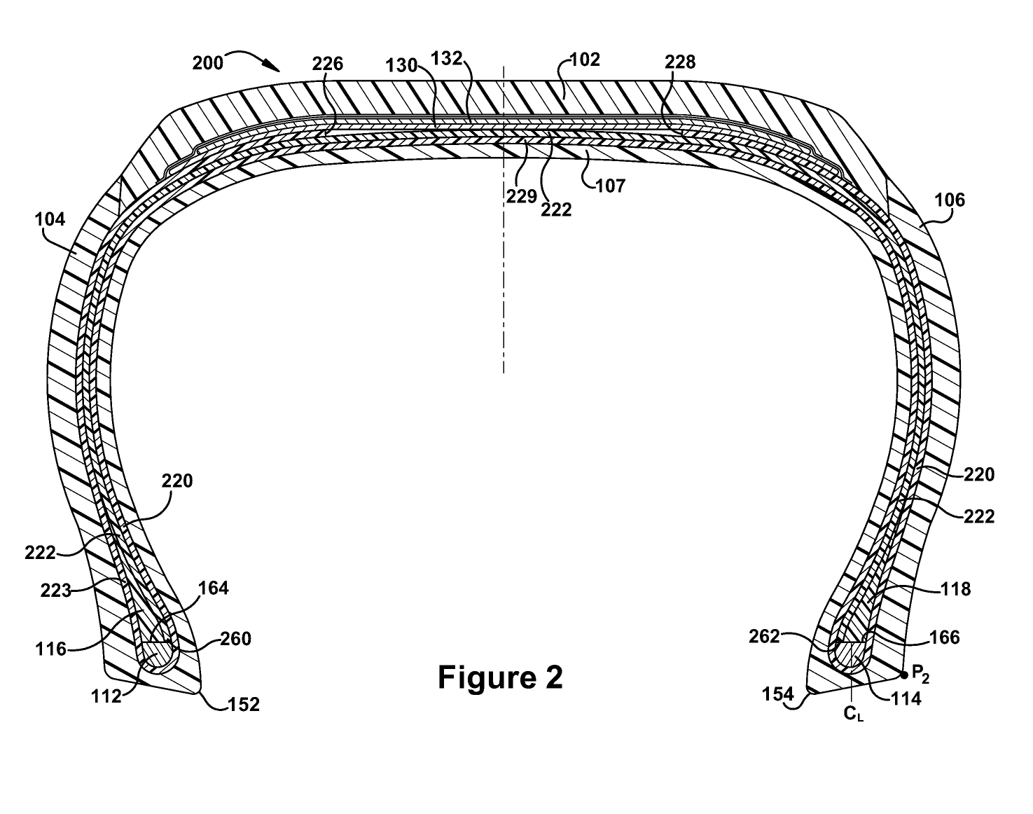

FIG. 2 shows a cross-sectional view of an alternative embodiment of a tire 200. Tire 200 includes first and second carcass plies 220, 222 which extend circumferentially about the tire 200 from one bead portion 108 to the other bead portion 110. The first carcass ply 220 is wound outwardly about the bead cores 108, 110 and extend upwardly towards the tread 102 to form turned-up portions 123, 124 adjacent sidewalls 104, 106, respectively. Each turned-up portion 123, 124 terminates at a turned-up end 126, 128, respectively. In this embodiment the second carcass ply 222 is disposed between the main portion 229 and the turned-up portions 223, 224 of the first carcass ply 220. The turned-up ends 226, 228 of the first carcass ply 220 are disposed between the second carcass ply 222 and belt 130.

The upper ends 226, 228 of the first carcass ply terminate beyond the shoulder regions 140, 142 of tire 200 and terminate beneath the tread portion 102 as described above with respect to the embodiment shown in FIG. 1. Also similar to that shown in FIG. 1, the height H₁ of the turned-up portions 123, 124 ranges from about 70% and about 99% of the section height H₀, which is measured from the outer tread surface at the equatorial plane Eₚ to the toe plane tₚ.

Second carcass ply 222 has ends 260, 262 which terminate in the lower section L of the tire 100. The location at which the ends 260, 262 of second carcass ply 220 terminate along the sidewalls can be expressed in terms of the section height H₀ of the tire. In one embodiment, the ends 260, 262 of second carcass ply 220 can terminate at a height H₂ measured from the toe plane tₚ which is up to 55% of the section height H₀ of the tire 200. In an alternative embodiment, the ends 260, 262 of second carcass ply 220 can terminate at a height H₂ from 1% to 20% of the section height H₀ of the tire 200. In another alternative embodiment, the ends 260, 262 of second carcass ply 220 can terminate at a height H₂ from 5% to 20% of the section height H₀ of the tire 200.

In one embodiment, as described above with respect to the ends 160, 162 of the second carcass ply of FIG. 1, the ends of 260, 262 can terminate at a minimum and maximum distance d above the heel plane hₚ of the tire. For example, ends 260, 262 of second carcass ply 222 can terminate along carcass plane cₚ which is a distance d above the heel plane hₚ. In one embodiment the ends 260, 262 terminate at a maximum distance of about 30 millimeters, in another embodiment a maximum distance of about 25 millimeters, and in another embodiment a maximum distance of about 20 millimeters above the heel plane hₚ of the tire. In another embodiment, the ends 260, 262 extend substantially to the top surfaces 164, 166 of bead cores 112, 114, respectively. In yet another embodiment the ends 260, 262 of the second carcass ply 222 can extend below the top surfaces 164, 166 and into or adjacent the bead cores 112, 114, respectively, and up to about the centerline, C_{L}, of the bead portions 112 and 114.

The first and second carcass plies 120, 122, 220 and 222 of FIGS. 1 and 2 have a thickness that can range from 0.4 mm to 2.5 mm. In an alternative embodiment, the first and second carcass plies 120, 122, 220 and 222 have a thickness that can range from about 0.5 mm to about 1.5 mm. In another alternative embodiment, the first and second carcass plies 120, 122, 220 and 222 have a thickness that can range from about 0.8 mm to about 1.2 mm. The second carcass plies 122, 222, have a thickness that can be the same or different than the first carcass plies 120, 220.

By providing two carcass plies in the sidewalls of a tire, sidewall performance of the tire is improved. As stiffness of the sidewall of the tire increases, surface strain in the sidewall of the tire decreases. Reduction of surface strain at the sidewall of the tire can lead to a reduction of deflection of the sidewall, prolonged life of the sidewalls, and improved vehicle handling. The Examples below show the reduction in surface strain at the sidewall where two carcass plies are used as described in the illustrated embodiments.

In one embodiment herein, the whole ply—that is, the main portion and turned-up portions—are made of the same organic fiber cords having a denier and cord diameter that is substantially the same. In other words, the organic fiber cords are continuous between the main portion and turned-up portions. The cord can be extruded with the body plies or can be calendared onto the body plies. In any of the various embodiments, the cords used in the first body ply can be materially the same or different than the cords used in the second body poly. Also, the number of cords per decimeter can vary between the first body ply and the second body ply.

The first and second carcass plies 120, 122, 220, 222 include parallel-aligned cords that are radially disposed. The parallel-aligned cords are oriented substantially perpendicular to the equatorial plane Eₚ of the tire 100. In alternative embodiments, one or more of the carcass plies can include parallel-aligned cords that are biased with respect to the equatorial plane Eₚ of the tire 100. The cords can be constructed of organic fiber cords, for example, nylon, rayon, polyester, aromatic polyamide and the like, and steel cords can also be used.

Each bead portion 108, 110 is further provided with a filler 116, 118 to reinforce the bead portion. The filler is made of synthetic or natural fiber similar to the above disposed between the carcass ply and the bead core so as to wrap the bead core therein. The elastomeric fillers extend from the radially outer portion of bead cores respectively, up into the sidewall portion gradually decreasing in cross-sectional width. The bead core is preferably constructed of a single or monofilament steel wire continuously wrapped.

The bead portions 108, 110 can optionally include a chafer (not shown), which is made of synthetic or natural fiber formed in a net-like shape, for example. The chafer extends along the axially inner surface and bottom surface of the bead portion and the axially outer surface of the carcass turned-up portion. The chafer adds protection to the bead area, and along with the bead filler, helps to increase the vertical and lateral rigidity of the bead portion.

The bead portions can also optionally include a bead filler insert. In one embodiment the bead filler insert can be extruded within the sidewalls, and in another embodiment calendared onto the carcass plies. The insert can be positioned above the bead filler, for example. The bead filler insert 214 is configured to serve as a cushion between the reinforcement plies 202, 214 and the carcass plies 114, 116. The bead filler insert 214 is constructed of rubber, but may be constructed of another elastomeric material. Although the bead filler insert 214 is illustrated as a separate component, it can be an extension of the bead filler 112.

Tires 100, 200 can optionally include a belt edge insert provided in the shoulder region of the tire between the edges of the first and second belts, respectively, and the first and second carcass plies. The belt edge insert has an inner end and an outer end. The belt edge insert is configured to protect the carcass plies from the edges of the belts. The belt edge insert can be constructed of extruded rubber, but may be constructed of another elastomeric material. Although shown in the FIG. 1 embodiment, the belt edge insert 136 is optional and may be omitted in alternative embodiments (not shown).

The tires 100, 200 of FIGS. 1 and 2 can also include at least one layer of reinforcement (not shown) provided between the first and second carcass plies 120, 122, 220, 222, and the sidewalls 104, 106 (or portions thereof) of the tires.

The following example demonstrates the potential effects of providing two carcass plies in the sidewalls of a tire according to various embodiments described above and should not be construed as limiting the scope or spirit of the present application.

### Example 1

A P255/45R18 tire, having a maximum allowable inflation of 35 psi and maximum load capacity of 1709 lb (hereinafter referred to as the “Control Tire”), was inflated to 19 psi. A computer simulated model of the Control Tire was created. A maximum load of 1709 lb was then applied to the Control Tire causing it to deflect. Modifications could be made to the computer simulated model of the Control Tire to create virtual tires. From the virtual tires, surface strain values along the surface of the sidewall of the tire could be predicted. In this case, the computer simulated model of the Control Tire was modified to create virtual tires that included one carcass ply extending circumferentially about the tire from one bead portion to the other, wrapping up to stabilizer ply ending and the second carcass ply turned down, either on the outside of the turned-up portion as shown in the embodiment of FIG. 1, or on the inside of turned-up portion as shown in the embodiment of FIG. 2, circumferentially from one bead portion to the other.

Table 1 below illustrates the sidewall surface strain results comparing the predicted surface strain values of the Control Tire with the predicted surface strain values of the embodiments shown in FIG. 1 (Example 1) and FIG. 2 (Example 2). As shown in Table 1, the predicted maximum sidewall surface strain of the Control Tire was 24.0%, while the predicted maximum sidewall surface strain of both Examples 1 and 2 was 20.5%. This represents a reduction in sidewall surface strain of 3.5%.

TABLE 1

| | Tire Size | | |
|---|---|---|---|
| | P255/45R18 | P255/45R18 | P255/45R18 |
| Body Ply | Control | Example 1 | Example 2 |
| Construction | | | |
| Predicted Max | 24.0% | 20.5% | 20.5% |
| Cyclic SWSS | | | |
| Predicted SWSS | BASE | −3.5% | −3.5% |
| Improvement | | | |

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.”

While embodiments of the invention have been described, it should be understood by those skilled in the art that various changes may be made and equivalence may be substituted without departing from the scope of the invention. For example, although example embodiments discussed above pertain to specific pneumatic tire features additional features are contemplated. In addition, many modifications may be made to adapt a particular situation of material to the teachings of the invention without departing from the essential scope thereof. For example, the various features of the first and second body plies can be combined with various designs and features of the pneumatic tires as shown and/or described throughout the various examples. Therefore, it is intended that the invention not be limited to particular embodiments, but that the invention will include all embodiments falling within the scope of the pending claims.

We claim:

1. A pneumatic tire comprising:
a tread portion;
a first bead portion and a second bead portion which are axially spaced;
a first sidewall portion and a second sidewall portion;
a first carcass ply comprising:
a main portion which extends circumferentially about the tire from the first bead portion to the second bead portion; and
a first turned-up portion around the first bead portion and a second turned-up portion around the second bead portion and wherein the first turned-up portion and the second turned-up portion each have an end which terminates along the tread portion; and
a second carcass ply which extends circumferentially about the tire along the first sidewall and the second sidewall, and wherein the second carcass ply has a first end and a second end which terminates in the lower portion of the tire.

2. The pneumatic tire of claim 1, wherein the second carcass ply which extends circumferentially about the tire is disposed between the turned-up portion of the first carcass ply and at least one of the sidewalls.

3. The pneumatic tire of claim 1, wherein the second carcass ply which extends circumferentially about the tire is disposed between the main portion of the first carcass ply and the turned-up portion of the first carcass ply.

4. The pneumatic tire of claim 1, wherein the tread portion comprises at least one belt having a first edge and a second edge, and wherein the first end and the second end of the first carcass ply terminate at a distance that ranges from about 15 to about 50 millimeters from the first edge and the second edge of the belt, respectively, extending inwardly toward the equatorial plane.

5. The pneumatic tire of claim 1, wherein the tire comprises an upper section and a lower section, and the ends of the second carcass ply terminate at a point in the lower section of the tire.

6. The pneumatic tire of claim 1, wherein the first and second sidewalls terminate at a heel which lies in a heel plane, and the ends of the second carcass ply terminate below a point having a maximum distance of about 20 millimeters above the heel plane.

7. The pneumatic tire of claim 1, wherein the first and second sidewalls terminate at a heel which lies in a heel plane, and the ends of the second carcass ply terminate above a point having a minimum distance of about 5 millimeters above the heel plane.

8. The pneumatic tire of claim 1, wherein the bead portions each comprise a bead core and the ends of the second carcass ply terminate proximate to the bead core.

9. The pneumatic tire of 1, wherein the cords of the first and second carcass plies are constructed of a material selected from the group consisting of polyimid, polyester, rayon, aramid and steel.

10. The tire of claim 1, wherein the first carcass ply has a thickness that ranges from about 0.4 millimeters to about 2.5 millimeters, and the second carcass ply has a thickness that ranges from about 0.4 millimeters and about 2.5 millimeters.

11. The tire of claim 1, wherein the turned-up portion has a height that is at least as great as about 70% of the section height of the tire.

12. The tire of claim 1, further comprising at least one belt extending circumferentially about the tire, the at least one belt provided between the tread and at least one of the first carcass ply and the second carcass ply.

13. The tire of claim 1, wherein the aspect ratio of the tire is less than about 55.

14. A pneumatic tire comprising:
a tread portion comprising a belt having a first edge and a second edge;
a first bead portion and a second bead portion which are axially spaced;
a first sidewall portion and a second sidewall portion;
a first carcass ply comprising:
a main portion which extends circumferentially about the tire from the first bead portion to the second bead portion; and
a first turned-up portion around the first bead portion and a second turned-up portion around the second bead portion and wherein the first turned-up portion has a first end and the second turned-up portion has a second end, wherein the first end and second end terminate a distance that ranges from about 15 to about 50 millimeters from the first edge and the second edge, respectively, of the belt; and
a second carcass ply which extends circumferentially about the tire from one bead portion to the other bead portion and has a first end which terminates between the first turned-up portion and the first sidewall in the lower portion of the tire, and a second end which terminates between the second turned-up portion and the second sidewall in the lower portion of the tire.

15. The pneumatic tire of claim 14, wherein the first end and the second end of the second carcass ply terminate proximate a first bead core of the first bead portion and a second bead core of the second bead portion, respectively.

16. A pneumatic tire comprising:
a tread portion comprising a belt having a first edge and a second edge;
a first bead portion and a second bead portion which are axially spaced;
a first sidewall portion and a second sidewall portion;
a first carcass ply comprising:
a main portion which extends circumferentially about the tire from the first bead portion to the second bead portion; and
a first turned-up portion around the first bead portion and a second turned-up portion around the second bead portion and wherein the first turned-up portion has a first end and the second turned-up portion has a second end, wherein the first end and second end terminate a distance that ranges from about 15 to about 50 millimeters from the first edge and the second edge, respectively, of the belt; and
a second carcass ply which extends circumferentially about the tire from one bead portion to the other bead portion and has a first end which terminates between the main portion and the first turned-up portion of the first carcass ply in the lower portion of the tire, and a second end which terminates between the main portion and the second turned-up portion of the first carcass ply in the lower portion of the tire.

17. The pneumatic tire of claim 16, wherein the first end and the second end of the second carcass ply terminate proximate a first bead core of the first bead portion and a second bead core of the second bead portion, respectively.

18. The pneumatic tire of claim 14, wherein the first and second sidewalls terminate at a heel which lies in a heel plane, and the ends of the second carcass ply terminate below a point having a maximum distance of about 20 millimeters above the heel plane.

19. The pneumatic tire of claim 18, wherein the first and second sidewalls terminate at a heel which lies in a heel plane, and the ends of the second carcass ply terminate above a point having a minimum distance of about 5 millimeters above the heel plane.

20. The tire of claim 19, wherein the aspect ratio of the tire is less than about 55.
